(19) United States
(12) Patent Application Publication
(10) Pub. No.: US 2019/0391851 A1
(43) Pub. Date: Dec. 26, 2019

(54) SYSTEM AND METHOD FOR MANAGING MEMORY IN VIRTUAL MACHINES

(71) Applicant: Nutanix, Inc., San Jose, CA (US)

(72) Inventors: Felipe Franciosi, Cambridge (GB); Malcolm Crossley, Cambridge (GB); David Vrabel, Cambridge (GB)

(21) Appl. No.: 16/014,188

(22) Filed: Jun. 21, 2018

(51) Int. Cl. G06F 9/50; G06F 11/07; G06F 9/455

(52) U.S. Cl. CPC G06F 9/5077; G06F 9/5016; G06F 2009/45583; G06F 11/0712; G06F 9/45558; G06F 11/0793

(57) ABSTRACT

A system and method include managing allocation of host physical memory to a guest physical memory of a virtual machine running on a computing node. The node includes hardware resources that are mapped the guest physical memory by a hypervisor. The hypervisor allocates a first amount of the host physical memory to the guest physical memory. The hypervisor also receives first page fault information. The hypervisor determines, based on the first page fault information, a first page fault rate. The hypervisor also determines that the first page fault rate is greater than a threshold rate, and allocates a second amount, greater than the first amount, of the host physical memory to the guest physical memory.

### BACKGROUND

The following description is provided to assist the understanding of the reader. None of the information provided or references cited is admitted to be prior art.

Virtual computing systems are widely used in a variety of applications. Virtual computing systems include one or more host machines running one or more virtual machines concurrently. The one or more virtual machines utilize the hardware resources of the underlying one or more host machines. Each virtual machine may be configured to run an instance of an operating system. Modern virtual computing systems allow several operating systems and several software applications to be safely run at the same time on the virtual machines of a single host machine, thereby increasing resource utilization and performance efficiency. However, present day virtual computing systems still have limitations due to their configuration and the way they operate.

### SUMMARY

In accordance with some other aspects of the present disclosure, a system is disclosed. The system includes a virtual machine including a guest operating system, at least one guest physical memory, at least one guest physical processor, and at least one guest physical swap storage. The system also includes a physical processing resource including at least one host physical memory, at least one host physical processor, and at least one host physical swap storage. The system also includes a hypervisor mapping the virtual machine to the physical resources. The hypervisor is configured to allocate a first amount of the host physical memory to the guest physical memory. The hypervisor is further configured to receive first page fault information. The hypervisor is also configured to determine, based on the first page fault information, a first page fault rate. The hypervisor is additionally configured to determine that the first page fault rate is greater than a threshold rate, and allocate a second amount, greater than the first amount, of the host physical memory to the guest physical memory.

In accordance with at least some aspects of the present disclosure, a method for managing allocation of a host physical memory of a host computing system to a guest physical memory of a virtual machine running on the host computing system is disclosed. The method includes allocating a first amount of the host physical memory to the guest physical memory of the virtual machine. The method further includes receiving first page fault information. The method also includes determining, based on the first page fault information, a first page fault rate. The method further includes determining that the first page fault rate is greater than a threshold rate, and allocating a second amount, greater than a first amount, of the host physical memory to the guest physical memory.

In accordance with at least some aspects of the present disclosure, a non-transitory computer-readable medium is disclosed. The non-transitory computer-readable medium having instructions stored, the instructions when executed by one or more processors, cause the one or more processors to allocate a first amount of a host physical memory to a guest physical memory, the host physical memory included in a host computing system, the guest physical memory assigned to a virtual machine running on the host computing system. The instructions cause the one or more processors to receive first page fault information. The instructions cause the one or more processors to determine, based on the first page fault information, a first page fault rate. The instructions cause the one or more processors to determine that the first page fault rate is greater than a threshold rate, and allocate a second amount, greater than the first amount, of the host physical memory to the guest physical memory.

The embodiments of the present disclosure are not be limited to a clustered or hyper-converged environment. The aspects of the present disclosure work with a single host in some embodiments.

The foregoing summary is illustrative only and is not intended to be in any way limiting. In addition to the illustrative aspects, embodiments, and features described above, further aspects, embodiments, and features will become apparent by reference to the following drawings and the detailed description.

### BRIEF DESCRIPTION OF THE DRAWINGS

FIG. 1 is a block diagram of a virtual computing system, in accordance with some embodiments of the present disclosure.

FIG. 2 shows a block diagram of a node used in a virtual computing system, in accordance with some embodiments of the present disclosure.

FIG. 3 shows an example allocation of host physical memory to the virtual machines, in accordance with some embodiments of the present disclosure.

FIG. 4 shows a flow diagram of a process for managing physical memory allocation for virtual machines on a host computer system, in accordance with some embodiments of the present disclosure.

FIG. 5 shows a diagram of an example timeline for monitoring page faults, in accordance with some embodiments of the present disclosure.

FIG. 6 shows a page fault rate table maintained by a hypervisor, in accordance with some embodiments of the present disclosure.

FIG. 7 illustrates an example decrease in the amount of host physical memory allocated to a virtual machine, in accordance with some embodiments of the present disclosure.

The foregoing and other features of the present disclosure will become apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

The present disclosure is generally directed to operating one or more virtual machines in a computing system using a hypervisor. The virtual machines can include an operating system, a guest physical processor, a guest physical memory, and a guest swap disk. The operating system can map virtual memory address space associated with each process to a portion of memory in the guest physical memory. In addition, the hypervisor can map the guest physical memory to a portion of a host physical memory on which the virtual machine is run. A size of the portion of the host physical memory allocated to the guest physical memory is typically predetermined by an administrator or a management module that creates the virtual machine. The administrator or the management module, based in part on a page fault rate and a threshold rate can dynamically change a size of the allocation of the host physical memory to the guest physical memory.

One technical problem encountered in such computing systems is the risk of under- or over-provisioning or under-allocating the host physical memory to the guest physical memory of the virtual machines. In some instances, the administrator or the management module may under-provision memory allocation to a virtual machine. That is, the amount of host physical memory allocated to the guest physical memory of the virtual machine is considerably less than that needed by virtual machine. This may result in repeated page faults, which can have adverse performance impact on the operation of the under-provisioned virtual machine. On the other hand, in some other instances, the administrator or the management module may over-provision or over-allocate the host physical memory to the guest physical memory of the virtual machine. That is, the amount of host physical memory allocated to the guest physical memory of the virtual machine is considerably greater than that needed by the virtual machine. While this may not have direct adverse impact the performance of the virtual machine, the over allocation may result in a less than ideal density of virtual machines being supported by the physical resources of the host. Another technical problem encountered in such computing systems is inability on the part of the administrator or the management module, to dynamically determine under- or over-provisioning and adjust the guest physical memory allocation to individual virtual machines.

The discussion below provides at least one solution to the technical problems mentioned above. For example, the hypervisor is configured to monitor a number of major page faults generated due to requested memory pages being absent in the host physical memory and instead being present in storage device. The hypervisor is configured to generate a page fault rate based on the number of page faults over a predetermined time period. The hypervisor compares the page fault rate with a threshold rate. If the measured page fault rate is greater than the threshold rate, the hypervisor can determine that the guest physical memory has been under-provisioned. The hypervisor can also increase a size of the portion of the host physical memory allocated to the guest physical memory. By increasing the allocation, the risk of page faults can be decreased, thereby potentially improving the performance of the virtual machine. The hypervisor can also be configured to determine whether the guest physical memory has been over-provisioned. The hypervisor can determine whether the page fault rate is less than or equal to the threshold rate. The page fault rate being greater than the threshold rate can indicate that the guest physical memory has been over-provisioned. The hypervisor can be configured to decrease the size of the portion of the host physical memory that is allocated to the guest physical memory of the virtual machine.

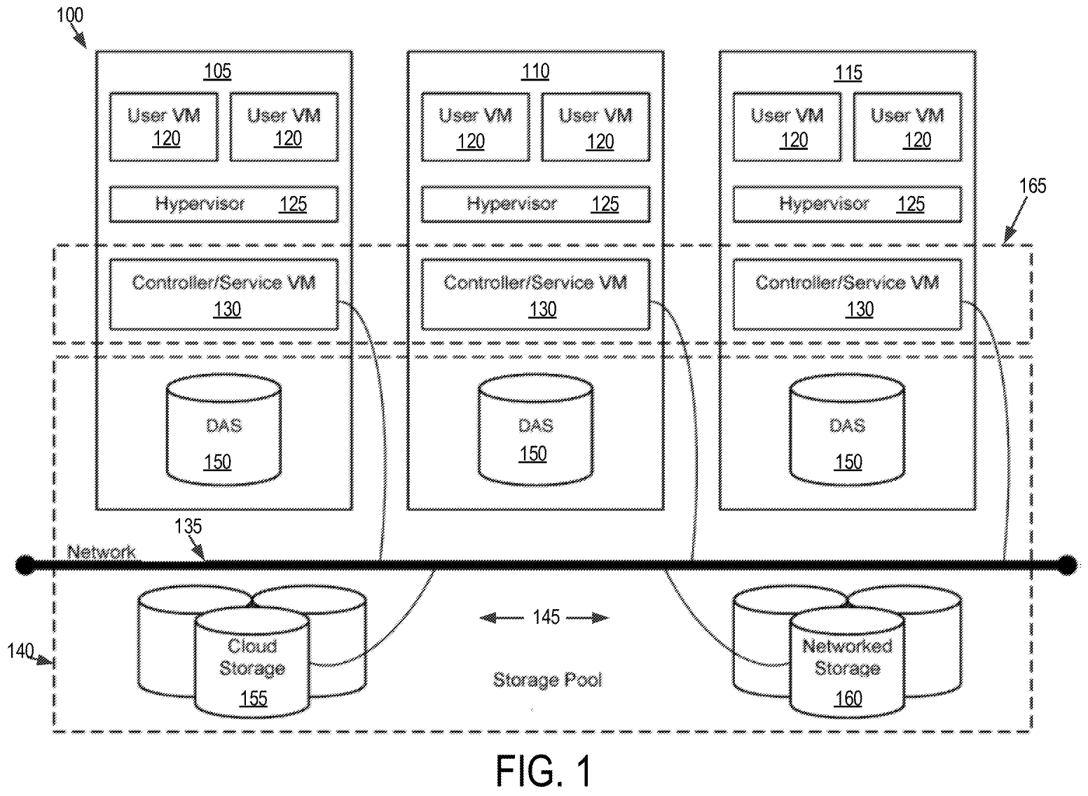

Referring now to FIG. 1, a virtual computing system 100 is shown, in accordance with some embodiments of the present disclosure. The virtual computing system 100 may be part of a datacenter. The virtual computing system 100 includes a plurality of nodes, such as a first node 105, a second node 110, and a third node 115. Each of the first node 105, the second node 110, and the third node 115 includes user virtual machines (VMs) 120 and a hypervisor 125 configured to create and run the user VMs. Each of the first node 105, the second node 110, and the third node 115 also includes a controller/service VM 130 that is configured to manage, route, and otherwise handle workflow requests to and from the user VMs 120 of a particular node. The controller/service VM 130 is connected to a network 135 to facilitate communication between the first node 105, the second node 110, and the third node 115. Although not shown, in some embodiments, the hypervisor 125 may also be connected to the network 135.

The virtual computing system 100 may also include a storage pool 140. The storage pool 140 may include network-attached storage 145 and direct-attached storage 150. The network-attached storage 145 may be accessible via the network 135 and, in some embodiments, may include cloud storage 155, as well as local storage area network 160. In contrast to the network-attached storage 145, which is accessible via the network 135, the direct-attached storage 150 may include storage components that are provided within each of the first node 105, the second node 110, and the third node 115, such that each of the first, second, and third nodes may access its respective direct-attached storage without having to access the network 135.

It is to be understood that only certain components of the virtual computing system 100 are shown in FIG. 1. Nevertheless, several other components that are commonly provided or desired in a virtual computing system are contemplated and considered within the scope of the present disclosure. Additional features of the virtual computing system 100 are described in U.S. Pat. No. 8,601,473, the entirety of which is incorporated by reference herein.

Although three of the plurality of nodes (e.g., the first node 105, the second node 110, and the third node 115) are shown in the virtual computing system 100, in other embodiments, greater or fewer than three nodes may be used. Likewise, although only two of the user VMs 120 are shown on each of the first node 105, the second node 110, and the third node 115, in other embodiments, the number of the user VMs on the first, second, and third nodes may vary to include either a single user VM or more than two user VMs. Further, the first node 105, the second node 110, and the third node 115 need not always have the same number of the user VMs 120. Additionally, more than a single instance of the hypervisor 125 and/or the controller/service VM 130 may be provided on the first node 105, the second node 110, and/or the third node 115.

Further, in some embodiments, each of the first node 105, the second node 110, and the third node 115 may be a hardware device, such as a server. For example, in some embodiments, one or more of the first node 105, the second node 110, and the third node 115 may be an NX-1000 server, NX-3000 server, NX-6000 server, NX-8000 server, etc. provided by Nutanix, Inc. or server computers from Dell, Inc., Lenovo Group Ltd. or Lenovo PC International, Cisco Systems, Inc., etc. In other embodiments, one or more of the first node 105, the second node 110, or the third node 115 may be another type of hardware device, such as a personal computer, an input/output or peripheral unit such as a printer, or any type of device that is suitable for use as a node within the virtual computing system 100.

Each of the first node 105, the second node 110, and the third node 115 may also be configured to communicate and share resources with each other via the network 135. For example, in some embodiments, the first node 105, the second node 110, and the third node 115 may communicate and share resources with each other via the controller/service VM 130 and/or the hypervisor 125. One or more of the first node 105, the second node 110, and the third node 115 may also be organized in a variety of network topologies, and may be termed as a “host” or “host machine.”

Also, although not shown, one or more of the first node 105, the second node 110, and the third node 115 may include one or more processing units configured to execute instructions. The instructions may be carried out by a special purpose computer, logic circuits, or hardware circuits of the first node 105, the second node 110, and the third node 115. The processing units may be implemented in hardware, firmware, software, or any combination thereof. The term “execution” is, for example, the process of running an application or the carrying out of the operation called for by an instruction. The instructions may be written using one or more programming language, scripting language, assembly language, etc. The processing units, thus, execute an instruction, meaning that they perform the operations called for by that instruction.

The processing units may be operably coupled to the storage pool 140, as well as with other elements of the respective first node 105, the second node 110, and the third node 115 to receive, send, and process information, and to control the operations of the underlying first, second, or third node. The processing units may retrieve a set of instructions from the storage pool 140, such as, from a permanent memory device like a read only memory (ROM) device and copy the instructions in an executable form to a temporary memory device that is generally some form of random access memory (RAM). The ROM and RAM may both be part of the storage pool 140, or in some embodiments, may be separately provisioned from the storage pool. Further, the processing units may include a single stand-alone processing unit, or a plurality of processing units that use the same or different processing technology.

With respect to the storage pool 140 and particularly with respect to the direct-attached storage 150, it may include a variety of types of memory devices. For example, in some embodiments, the direct-attached storage 150 may include, but is not limited to, any type of RAM, ROM, flash memory, magnetic storage devices (e.g., hard disk, floppy disk, magnetic strips, etc.), optical disks (e.g., compact disk (CD), digital versatile disk (DVD), etc.), smart cards, solid state devices, etc. Likewise, the network-attached storage 145 may include any of a variety of network accessible storage (e.g., the cloud storage 155, the local storage area network 160, etc.) that is suitable for use within the virtual computing system 100 and accessible via the network 135. The storage pool 140 including the network-attached storage 145 and the direct-attached storage 150 may together form a distributed storage system configured to be accessed by each of the first node 105, the second node 110, and the third node 115 via the network 135 and the controller/service VM 130, and/or the hypervisor 125. In some embodiments, the various storage components in the storage pool 140 may be configured as virtual disks for access by the user VMs 120.

Each of the user VMs 120 is a software-based implementation of a computing machine in the virtual computing system 100. The user VMs 120 emulate the functionality of a physical computer. Specifically, the hardware resources, such as processing unit, memory, storage, etc., of the underlying computer (e.g., the first node 105, the second node 110, and the third node 115) are virtualized or transformed by the hypervisor 125 into the underlying support for each of the plurality of user VMs 120 that may run its own operating system and applications on the underlying physical resources just like a real computer. By encapsulating an entire machine, including CPU, memory, operating system, storage devices, and network devices, the user VMs 120 are compatible with most standard operating systems (e.g. Windows, Linux, etc.), applications, and device drivers. Thus, the hypervisor 125 is a virtual machine monitor that allows a single physical server computer (e.g., the first node 105, the second node 110, and third node 115) to run multiple instances of the user VMs 120, with each user VM sharing the resources of that one physical server computer, potentially across multiple environments. By running the plurality of user VMs 120 on each of the first node 105, the second node 110, and the third node 115, multiple workloads and multiple operating systems may be run on a single piece of underlying hardware computer (e.g., the first node, the second node, and the third node) to increase resource utilization and manage workflow.

The user VMs 120 are controlled and managed by the controller/service VM 130. The controller/service VM 130 of each of the first node 105, the second node 110, and the third node 115 is configured to communicate with each other via the network 135 to form a distributed system 165. The hypervisor 125 of each of the first node 105, the second node 110, and the third node 115 may be configured to run virtualization software, such as, ESXi from VMWare, AHV from Nutanix, Inc., XenServer from Citrix Systems, Inc., etc., for running the user VMs 120 and for managing the interactions between the user VMs and the underlying hardware of the first node 105, the second node 110, and the third node 115. The controller/service VM 130 and the hypervisor 125 may be configured as suitable for use within the virtual computing system 100.

The network 135 may include any of a variety of wired or wireless network channels that may be suitable for use within the virtual computing system 100. For example, in some embodiments, the network 135 may include wired connections, such as an Ethernet connection, one or more twisted pair wires, coaxial cables, fiber optic cables, etc. In other embodiments, the network 135 may include wireless connections, such as microwaves, infrared waves, radio waves, spread spectrum technologies, satellites, etc. The network 135 may also be configured to communicate with another device using cellular networks, local area networks, wide area networks, the Internet, etc. In some embodiments, the network 135 may include a combination of wired and wireless communications.

Referring still to FIG. 1, in some embodiments, one of the first node 105, the second node 110, or the third node 115 may be configured as a leader node. The leader node may be configured to monitor and handle requests from other nodes in the virtual computing system 100. If the leader node fails, another leader node may be designated. Furthermore, one or more of the first node 105, the second node 110, and the third node 115 may be combined together to form a network cluster (also referred to herein as simply “cluster.”) Generally speaking, all of the nodes (e.g., the first node 105, the second node 110, and the third node 115) in the virtual computing system 100 may be divided into one or more clusters. One or more components of the storage pool 140 may be part of the cluster as well. For example, the virtual computing system 100 as shown in FIG. 1 may form one cluster in some embodiments. Multiple clusters may exist within a given virtual computing system (e.g., the virtual computing system 100). The user VMs 120 that are part of a cluster may be configured to share resources with each other.

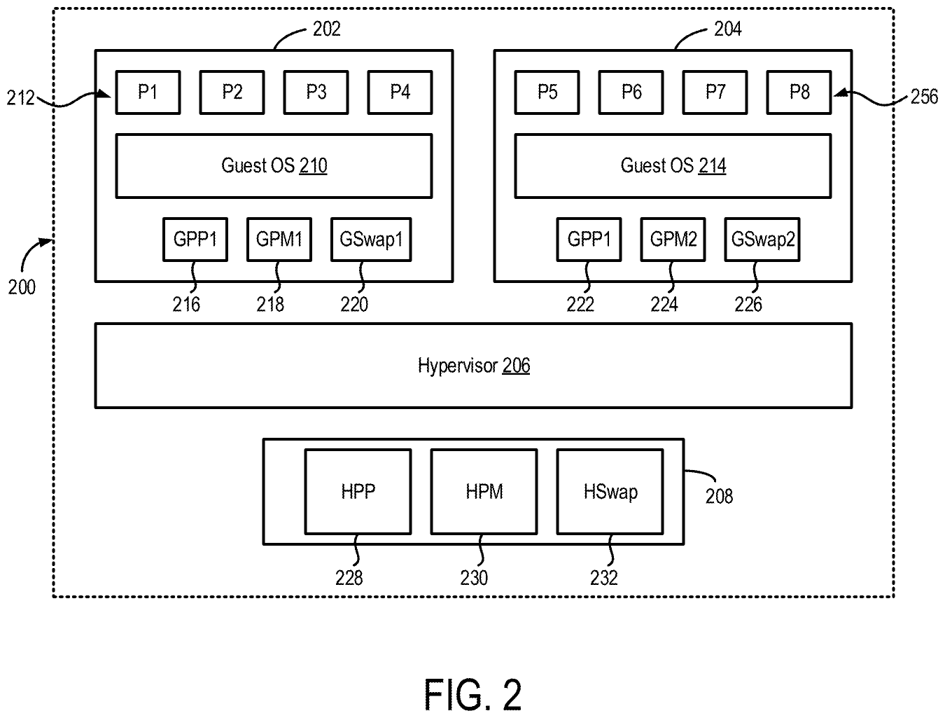

FIG. 2 shows a block diagram of a node 200 used in a virtual computing system, in accordance with some embodiments of the present disclosure. The node 200 shown in FIG. 2, for example, can be used to implement one or more of the first node 105, the second node 110, and the third node 115 discussed above in relation to FIG. 1. The node 200 includes a first user VM 202, a second user VM 204, a hypervisor 206, and physical hardware resources 208. The first user VM 202 and the second user VM 204 can be similar to the user VMs 120 discussed above in relation to FIG. 1. In addition, the first user VM 202 can include a first guest operating system (OS) 210 that can run a first set of processes 212 (P1, P2, P3, and P4). Similarly, the second user VM 204 can include a second guest OS 214 that can run a second set of processes 256 (P5, P6, P7, and P8). The number of processes in the first and the second set of Processes 212 and 216 shown in FIG. 2 are only examples, and that the respective guest OSs may run fewer or more processes at any given time.

The first user VM 202 also can include one or more guest physical processers, guest physical memories, and guest swap disks. For example, the first user VM 202 can include a first guest physical processor (GPP1) 216, a first guest physical memory (GPM1) 218, and a first guest swap disk (GSwap1) 220. Similarly, the second user VM 204 can include a second guest physical processor (GPP2) 222, a second guest physical memory 224, and a second guest swap disk 226. The number of guest physical processors, guest physical memories, and guest swap disks shown in FIG. 2 are merely an example, and that in other implementations, the first and the second user VMs 202 and 204 may include additional number of guest physical processors, guest physical memories, and guest swap disks. While not shown in FIG. 2, each of the first and the second user VMs 202 and 204 can include a guest physical storage disk. In one or more embodiments, the guest swap disk can be a partition on the guest physical storage disks. It should be noted that the GPP1 216, the GPM1 218, the GSwap1 220, the GPP2 222, GPM2 224, and the GSwap2 226 are not actually physical memories, but virtual processing, memory and storage objects that the hypervisor 206 provides to the first and second user VMs 202 and 204. These virtual objects are the result of the virtualization implemented by the hypervisor 206. In one or more embodiments, the hypervisor 206 may present the same guest physical memory to both the first and the second user VM 202 and 204.

The hypervisor 206 can implement processor, memory, and storage virtualization by abstracting the hardware resources 208 including processors, memory, and I/O devices, and present the abstraction to the first and the second user VMs 202 and 204 as the guest physical processors, guest physical memories and guest swap disks. For example, the hypervisor 206 can implement processor virtualization by scheduling time slots on one or more physical processors of the hardware resources 208 such that from the guest OS's perspective, the time slots are scheduled on the guest physical processors. The hypervisor 206 can implement memory virtualization by maintaining a translation table that translates memory addresses assigned by the guest OSs to physical memory addresses in the physical memories of the hardware resources 208.

The hardware resources 208 can include several processors and memories. While not shown in FIG. 2, the hardware resources may also include one or more I/O resources which can be virtualized and presented as guest physical I/O resources to the first and the second user VMs 202 and 204. The hardware resources 208 can include a host physical processor (HPP) 228, a host physical memory (HPM) 230, and a host swap disk (HSwap) 232. It is understood that the hardware resources 208 can include additional HPPs, HPMs, and HSwap. The HPP 228, the HPM 230 and the HSwap 232 are physical hardware devices such as processor and memory chips that provide physical processing and storage of data. The hardware resources 208 can be shared by the various guest physical processors, guest physical memories and guest swap disks included in the first and the second user VMs 202 and 204.

Each guest OS in the user VMs can provide a virtual memory space to the one or more processes running on the guest OS. For example, the first guest OS 210 can provide a virtual memory space in a first virtual memory to each of the four processes P1-P4 212 running on the first guest OS 210. Similarly, the second guest OS 214 can provide a virtual memory space in a second virtual memory to each of the four processes P5-P8 256 running on the second guest OS 214. The virtual memory space provided to the processors can be divided into blocks of a certain size (such as, for example, 4 kB) and can be referred to as pages. Each guest OS maps the virtual memory space provided to each processor to the respective guest physical memory. For example, the first guest OS 210 can map the virtual memory space provided to each process in the first set of processes 212 to memory locations in the GPM1 218. Similarly, the second guest OS 214 can map the virtual memory space provided to each process in the second set of processes 256 to memory locations in the GPM2 224. The information mapping the virtual memory space seen by the processes to the guest physical memory can be stored in page table. The guest OS can create a page table for each process, and map the virtual memory addresses within the virtual memory space provided to that process to memory locations in the guest physical memory. For example, the first guest OS 210 can generate a page table for each of the four processes in the first set of processes 212. Whenever a process is being executed, the guest OS can load the page table corresponding to that process to determine addresses mappings to the guest physical memory.

The hypervisor 206 also maintains a memory map. Specifically, the hypervisor 206 stores memory mapping between the guest physical memories (GPM1 218 and GPM2 224) and the host physical memory 230 in the hardware resources 208 of the host. The hypervisor 206 can store this mapping information in a physical mapping table, which maps memory locations in the guest physical memories to the host physical memories. Thus, the combined mapping information included in the page tables and the physical mapping table can provide mapping between the virtual memory space seen by a process and the physical memory location in the host physical memory.

The hypervisor 206 may also maintain a mapping between the guest physical storage and the host physical storage. For example, the hypervisor 206 can store mapping information between storage addresses in the GSwap1 220 and the corresponding addresses in the HSwap 232. Similarly, the hypervisor can also store mapping information between the addresses in the GSwap2 226 and the corresponding addresses in the HSwap 232.

The hypervisor 206 can allocate a certain amount of host physical memory 230 to each of the guest physical memories. For example, the hypervisor 206 can allocate a portion of the host physical memory 230 to the guest physical memory GPM1 218 of the first user VM 202, and another portion of the host physical memory 230 to the guest physical memory GPM2 224 of the second virtual machine 204. In this manner, the hypervisor 206 can distribute the available host physical memory 230 to the one or more virtual machines supported by the hypervisor 206.

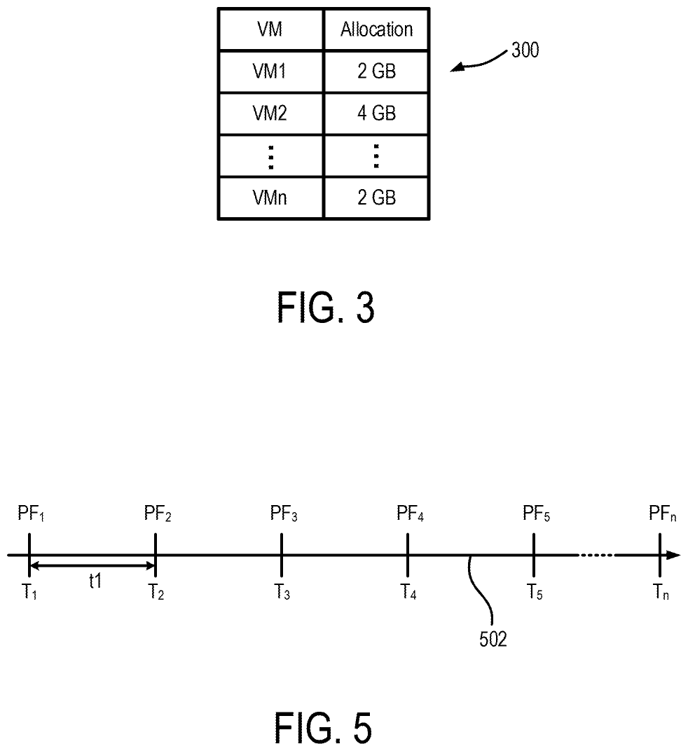

FIG. 3 shows an example allocation of host physical memory to the virtual machines. An allocation table 300 lists the identities of the virtual machines supported by the hypervisor 206 and the corresponding allocation of host physical memory. For example, a first virtual machine “VM1” is allocated 2 GB of the host physical memory 230, a second virtual machine “VM2” is allocated 4 GB of the host physical memory 230, and an nth virtual machine “VMn” is allocated 6 GB of the host physical memory 230. The allocations shown in FIG. 3 are only examples, and the actual allocations of the host physical memory 230 to the virtual machines supported by the hypervisor 206 may vary based on the particular implementation. As an example, the allocations to the first virtual machine “VM1” and the second virtual machine “VM2” in FIG. 3 can correspond to the allocations to the first user VM 202 and the second user VM 204 shown in FIG. 2. In some examples, the total allocation of memory to the virtual machines may not exceed the total size of the host physical memory 230. For example, if the size of the host physical memory 230 is 16 GB, then the sum of the allocations to the various virtual machines supported by the hypervisor 206 may not exceed 16 GB. The hypervisor 206 can maintain the allocation table 300 in addition to maintaining the mapping of the address space in the guest physical memories (e.g., GPM1 218 and GPM2 224) to the corresponding portions of the host physical memory 230. The allocation table 300 as well as the mapping can be dynamically updated by the hypervisor 206 to reflect any changes in the allocation or in the mapping. In an exemplary embodiment, the page fault threshold is determined experimentally to give a balance between performance, memory usage, and convergence rate (i.e., how quickly the working set is reached). Generally, higher rates give worse performance, reduced memory and faster convergence. Lower rates gives better performance, increase memory, and slower convergence. The threshold rate may be scaled linearly with the number of guest processors. R=k*P+c (where P is the number of guest processors, and k and c are constants determined experimentally).

The sizes of the portions of the host physical memory 230 allocated to the first guest physical memory 218 and the second guest physical memory 224 can have an impact on the performance of the respective virtual machines and the node 200. For example, if the allocation is relatively smaller than the memory address space frequently accessed by a guest physical memory, then the hypervisor 206 or the memory management unit of the host may have to swap-out pages in the host physical memory 230 into the host swap storage 232. Thus, the next time a process running on the virtual machine accesses an address space that maps to the swapped out page in the host physical memory, the host physical processor 228 may generate a major page fault. Upon generation of the major page fault, the hypervisor 206, or the memory management unit of the node 200, can swap-in the requested page from the host swap storage 232 back into the host physical memory 230. If the host physical memory 230 is full, another portion of the host physical memory 230 including other pages may have to be swapped-out to the host swap storage 232 to make space for the swapped-in pages. The swapping-in and swapping-out of the pages between the host physical memory 230 and the host swap storage 232 can adversely impact the performance of the virtual machine. One approach to reducing the number of page faults is to increase the size of the portion of the host physical memory 230 allocated to the virtual machine. However, increasing the allocation may result in over-provisioning if the added allocation of host physical memory space goes under-utilized. As a result, the density of the virtual machines supported by the host physical memory 230 may be lower than what can be actually accommodated.

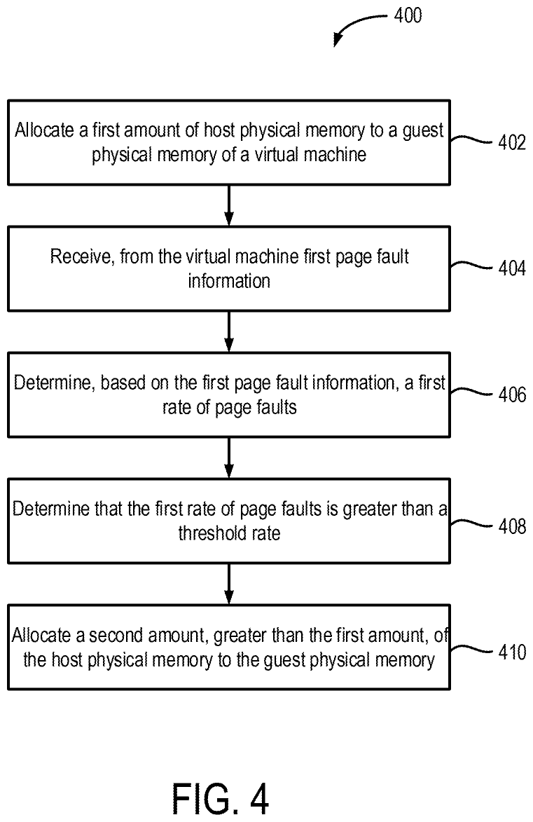

FIG. 4 shows a flow diagram of a process 400 for managing physical memory allocation for virtual machines on a host computer system. Additional, fewer, or different operations may be performed depending on the implementation. The process 400 includes allocating a first amount of host physical memory to a guest physical memory of a virtual machine (402). Referring to FIG. 3, the allocation table 300 shows a list of virtual machines and the corresponding allocation of host physical memory. For example, the first virtual machine “VM1” is allocated 2 GB of memory space on the host physical memory 230, the virtual machine “VM2” is allocated 4 GB of memory space on the host physical memory 230, and the n-the virtual machine “VMn” is allocated 2 GB of memory space on the host physical memory 230. The hypervisor 206 can allocate memory space on the host physical memory 230 to the virtual machines when the virtual machines are launched. The hypervisor 206 may also allocate memory space at a later time. The allocation of memory space on the host physical memory 230 to the virtual machines can be constrained by the overall size of the host physical memory 230. Thus, the total allocation of memory space on the host physical memory 230 may not exceed the overall size of the host physical memory.

The process further includes receiving first page fault information (404). The hypervisor 206 can receive first page fault information on page faults related to the host physical memory 230. For example, the first guest OS 210 of the first user VM 202 may request to read or write data in a particular address space. If the memory page associated with the address space is not located in the host physical memory 230, but is instead located in the host swap storage 232, or other physical storage, a page fault can occur. The host physical processor 228 can generate an exception in response to determining that the requested page is not located in the host physical memory 230 and that it is instead located in the host swap storage 232 or other storage. This exception can constitute a page fault. The exceptions generated by the host physical processor 228 can be monitored by the hypervisor 206. In some examples, the hypervisor 206 can repeatedly monitor the occurrence of page faults over time to determine a rate of page faults.

FIG. 5 shows a diagram of an example timeline for monitoring page faults. In particular, FIG. 5 shows a time line 505 and discrete time instances at which the hypervisor 206 determines the number of page faults generated in relation to the first user VM 202. The hypervisor 206 can poll the host physical processor 228 or the memory management unit of the node 200 to determine the page faults generated by the memory operations carried out for the first user VM 202. For example, at time T₁, the hypervisor 206 can poll the host physical processor 228 or the memory management unit of the node 200 and receive a number of page faults equal to PF₁. At time T₂, the hypervisor 206 again polls for the page fault information, and receives a number of page faults equal to PF₂. Similarly, the hypervisor 206 can poll, and in response, receive the number of page faults at each of the time instances T₃, T₄, T₅, and Tₙ. The instances when the hypervisor 206 polls for page fault information can be spaced equally apart. For example, the time duration t1 between subsequent polling instances can be about 0.5 seconds to about 1.5 seconds or about 1 second. In some examples, the hypervisor 206 can poll for page fault information at irregular time intervals. For example, the hypervisor 206 can poll for page fault information at random time periods within a particular rage, such as, for example, 0.5 seconds to about 1.5 seconds.

The page fault information received by the hypervisor 206 can include the page fault numbers received at one or more instances. For example, the page fault information received by the hypervisor can include the page fault numbers PF1 and PF2 received at time instances T₁ and T₂. The hypervisor 206 can be configured to poll and receive page fault information related to more than one virtual machine. For example, the hypervisor 206 can receive page fault information associated with the first user VM 202 and page fault information associated with the second user VM 204. The hypervisor 206 can store the received page fault information associated with each virtual machine in memory. For example, the hypervisor 206 can store the page fault information for the respective virtual machines over a period of time, such as, for example, 1 minute to about 2 minutes, or longer.

The process 400 also includes determining, based on the page fault information, a first rate of page faults (406). The hypervisor 206 can determine a first rate of page faults associated with a virtual machine based on the page fault information, such as the number of page faults at one or more time instances. In some examples, the hypervisor 206 can be configured to determine the rate of page faults per unit of time, where the unit of time can be in milliseconds, seconds, minutes, or any other unit of time. Based on the desired unit of time over which the rate is to be determined, and the instances over which the page fault information is received, the hypervisor 206 can determine a first page fault rate. As an example, referring to FIG. 5, assuming that the hypervisor 206 receives the page fault numbers PF1 and PF2 at times T₁ and T₂, which are one second apart, and that the page fault numbers represent a cumulative count of the page faults, the hypervisor can determine the first page fault rate as (PF2-PF1) per second. Also assuming that the time instances in FIG. 5 are equally spaced in time and separated by one second, the hypervisor 206 can determine the page fault rates any instant by subtracting the page fault number at an immediately previous instant from the page fault number at the current instant. Thus, the page fault rate at time T₃ can be determined as (PF3-PF2) per second, that at time T₄ can be determined as (PF4-PF3) per second, and so on. The hypervisor 206 may also be configured to take an average over a longer time period to determine the rate. For example, the hypervisor 206 can determine the page fault rate based on the difference between the page fault numbers at times T₁ and T₅ divided by the difference between times T₁ and T₅, to obtain a rate of page faults per second.

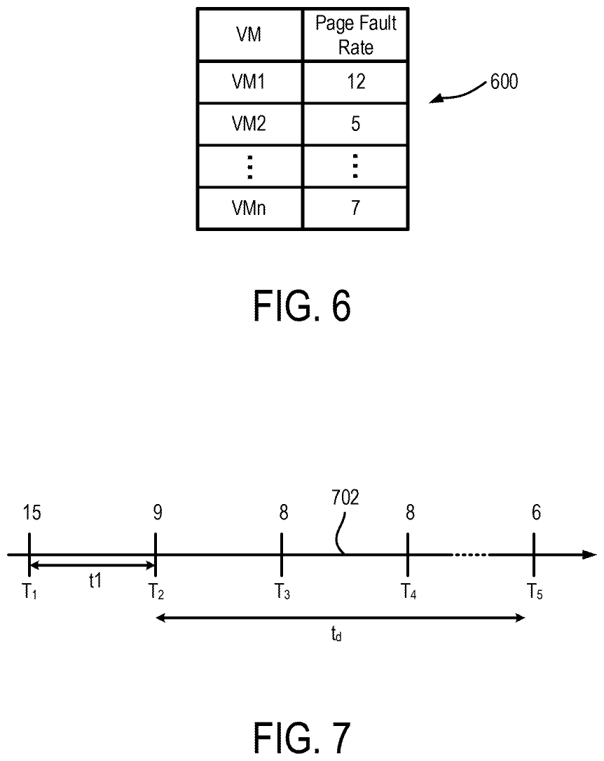

The hypervisor 206 can maintain page fault rate values for each of the virtual machines supported by the hypervisor 206. For example, FIG. 6 shows a page fault rate table 600 that includes the identities of the various virtual machines supported by the hypervisor and the corresponding determined page fault rates. As an example, FIG. 6 shows that the page fault rate for the first virtual machine “VM1” is 12 page faults per second, that for the second virtual machine “VM2” is 5 page faults per second, and that for the n-th virtual machine “VMn” is 7 page faults per second. The hypervisor 206 can update the page fault rate table 600 at predetermined intervals. For example, the hypervisor 206 can update the page fault rate table 600 every second, or in response to receiving new page fault information.

The process 400 additionally includes determining that the first rate of page faults is greater than a threshold rate (408). The hypervisor 206 can store in memory a threshold rate that can be representative of a value which if exceeded can be indicative of degraded performance of the virtual machine. In some examples, the threshold rate can be experimentally determined to balance performance, memory usage, and convergence rate. The threshold rate may be scaled linearly with the number of guest processors. R=k*P+c (where P is the number of guest processors, and k and c are constants determined experimentally). In some examples, the threshold rate can be a constant. In some examples, the threshold rate can be varied based on various parameters of the virtual machine. For example, the threshold rate can be a function of the number of guest physical processors (e.g., GPP1 216) in the virtual machine. However, the process 400 is not specific to a clustered or hyper-converged environment and would work with a single host. In some examples, the threshold rate can increase linearly with the number of guest physical processors in the virtual machine.

The process 400 also includes allocating a second amount, greater than the first amount, of the host physical memory to the guest physical memory (410). The hypervisor 206 can determine that the page fault rate associated with a virtual machine is greater than a threshold value. This can indicate that the performance of the associated virtual machine is being adversely impacted by the size of the portion of the host physical memory allocated to the virtual machine. One approach to reducing the number of page faults is to allocate a larger portion of the host physical memory to the virtual machine. For example, referring to FIG. 3, the guest physical processor of the first virtual machine “VM1” is allocated 2 GB of memory on the host physical memory. If the page fault rate associated with the first virtual machine “VM1” is determined to be greater than the threshold rate, the hypervisor 206 can increase the allocation from 2 GB to a value that is greater than 2 GB, such as, for example, 3 GB. By increasing the amount of host physical memory to the guest physical memory of the first virtual machine “VM1”, the risk of pages being swapped out to the storage is reduced. As a result, the risk of page fault is reduced, thereby potentially decreasing the page fault rate associated with the first virtual machine “VM1.” The potential decrease in the page fault rate associated with the first virtual machine “VM1,” can, in turn, reduce the performance impact on the first virtual machine “VM1.”

The hypervisor 206 can continue to monitor the page fault rate associated with the first virtual machine “VM1,” over time, and continue to incrementally increase the allocation to the virtual machine until the page fault rate is less than or equal to the threshold rate. In some examples, the hypervisor 206 can monitor the page fault rate at a higher frequency during the increase in the allocation until the page fault rate is equal to or greater than the threshold rate. In some examples, the hypervisor 206 can determine the size of increase in the allocation based on the severity of the page fault rate. For example, the hypervisor 206 can determine the increase in allocation as a function of the difference between the determined page fault rate and the threshold value. In some examples, the hypervisor 206 can determine the increase in the allocation to be proportional to the difference between the determined page fault rate and the threshold value. Thus, greater the difference between the page fault value and the threshold rate, greater is increase in allocation of the host physical memory to the virtual machine. Thus, at a given time, the hypervisor 206 can increase the allocation by a certain amount based on the difference between the page fault rate and the threshold value. Due to the increase in allocation, the page fault rate may decrease in the next instance that the page fault rate is determined. As the difference between the page fault rate and the threshold rate is decreased, the hypervisor 206, while still increasing the allocation to the virtual machine, may reduce the amount by which the allocation is increased. In some examples, the hypervisor 206 can increase the allocation by a constant amount each time the hypervisor 206 determines that the page fault rate is greater than the threshold value.

In some instances, the hypervisor 206 can decrease the allocation of host physical memory to the virtual machine responsive to determining that the page fault rate is less than or equal to the threshold value. For example, determining that the page fault value is less than or equal to the threshold value may indicate that the guest physical memory is being over-provisioned. The over-provisioning of the guest physical memory can reduce the efficiency of the node 200. For example, due to the over-provisioning, the node 200 may be supporting a fewer number of virtual machines that it actually can. To improve the virtual machine density on the node 200, the hypervisor 206 can decrease the allocation or de-allocate the amount of host physical memory to the guest physical memory of the virtual machine. Thus, for example, assuming the threshold rate is 10, and the current page fault rate is 8, which is less than the threshold rate. As a result, the hypervisor 206 can decrease the allocation from, say, e.g., 4 GB to 3 GB. The de-allocation of the amount of host physical memory to the virtual machine may continue if the page fault rate continues to remain below or equal to the threshold rate. The hypervisor 206 can use the de-allocated amount of host physical memory for allocation to an additional virtual machine, or to increase the allocation to an existing virtual machine that is perhaps experiencing page fault rates that are greater than the threshold value.

In some examples, the hypervisor 206 may decrease allocation relatively slowly than the rate at which it increases allocation. For example, the hypervisor 206 can increase allocation every time the hypervisor 206 determines that the page fault rate is greater than the threshold value. In some scenarios, this can mean that the hypervisor 206 increases allocation each time the page fault number is polled and the determined page fault rate is still greater than the threshold rate. On the other hand, the hypervisor 206 may decrease allocation of the amount of host physical memory at a relatively slower rate. For example, the hypervisor 206 can set a delay time period between any two successive decreases the allocation for a virtual machine, where the delay time period is greater than the polling time period.

FIG. 7 illustrates an example decrease in the amount of host physical memory allocated to a virtual machine. In particular, FIG. 7 shows a time line 702 with discrete instances such as T₁, T₂, T₃, T₄, and T₅, at which the hypervisor 206 polls for page fault information and determines the corresponding page fault rate. As an example, at time T₁, the hypervisor 206 determines that the page fault rate is 15. Assuming that the threshold rate is 10, the hypervisor 206 can increase the allocation of the amount of host physical memory to the virtual machine. This can cause the page fault rate to decrease, as is evident at time T₂, where the hypervisor 206 determines the page fault rate to be equal to 9. As the determined page fault rate is now less than the threshold rate, the hypervisor 206 can decrease the amount of the host physical memory is allocated to the virtual machine. However, the hypervisor 206 can also set a timer equal to a delay time period t_{d}. The hypervisor 206 can be configured to refrain from further decreasing the allocation until after the timer is elapsed. Thus, at time T₃, even though the page fault rate is 8, which is less than the threshold rate of 10, the hypervisor 206 does not decrease the allocation. Similarly, at time T₄, the hypervisor 206 is prevented from further decreasing the allocation. At time T₅, the hypervisor 206 determines that the page fault rate is 6, which is less than the threshold rate. But because time T₅ occurs after the elapse of the delay time period t_{d}, the hypervisor 206 can proceed with the decrease in the allocation. The hypervisor 206 may again restart the timer, so that no further decrease of allocation occurs until after the elapse of the delay time period t_{d}.

While the examples above have been discussed in relation to one virtual machine, it is understood that the hypervisor 206 can simultaneously dynamically control the allocation and de-allocation of host physical memory to more than one virtual machine. For example, referring to FIG. 2, the hypervisor 206 can simultaneously dynamically control the allocation and de-allocation of the host physical memory 230 to the first user VM 202 and the second user VM 204 in the manner discussed above.

It is to be understood that in some embodiments, any of the operations described herein may be implemented at least in part as computer-readable instructions stored on a computer-readable memory. Upon execution of the computer-readable instructions by a processor, the computer-readable instructions may cause a node to perform the operations.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

1. An apparatus comprising:
a processor comprising programmed instructions to:
allocate a first amount of a host physical memory to a guest physical memory of a virtual machine;
receive first page fault information associated with the virtual machine at a first time instance and a second time instance;
determine, based on the first page fault information received at the first time instance and the second time instance, a first page fault rate;
determine that the first page fault rate is greater than a threshold rate; and
allocate a second amount, greater than the first amount, of the host physical memory to the guest physical memory.

2. The apparatus of claim 1, wherein the processor further includes programmed instructions to:
receive second page fault information subsequent to receiving the first page fault information;
determine, based on the second page fault information, a second page fault rate;
determine that the second page fault rate is less than the threshold rate;
allocate a third amount, less than the second amount, of the host physical memory to the guest physical memory.

3. The apparatus of claim 2, wherein the processor comprises programmed instructions to:
receive third page fault information subsequent to receiving the second page fault information;
determine, based on the third page fault information, a third page fault rate;
determine that the third page fault rate is less than the threshold rate;
determine that the third page fault information is received greater than a delay time period after the receipt of the second page fault information; and
allocate a fourth amount, less than the third amount, of the host physical memory to the guest physical memory.

4. The apparatus of claim 1, wherein the first page fault information includes a first number of page faults associated with the virtual machine at the first time instance and a second number of page faults associated with the virtual machine at the second time instance, and wherein the first page fault rate is equal to a ratio of a difference between the second number of page faults and the first number of page faults to a difference between the second time instance and the first time instance.

5. The apparatus of claim 1, wherein a difference between the second amount and the first amount is a function of a difference between the first page fault rate and the threshold rate.

6. The apparatus of claim 1, wherein the threshold rate is based on a number of guest physical processors associated with the virtual machine.

7. A method comprising:
allocating a first amount of a host physical memory to a guest physical memory of a virtual machine;
receiving first page fault information associated with the virtual machine at a first time instance and a second time instance;
determining, based on the first page fault information received at the first time instance and the second time instance, a first page fault rate;
determining that the first page fault rate is greater than a threshold rate; and
allocating a second amount, greater than a first amount, of the host physical memory to the guest physical memory.

8. The method of claim 7, further comprising:
receiving second page fault information subsequent to receiving the first page fault information;
determining, based on the second page fault information, a second page fault rate;
determining, that the second page fault rate is less than the threshold rate; and
allocating a third amount, less than the second amount, of the host physical memory to the guest physical memory.

9. The method of claim 8, further comprising allocating the third amount of the host physical memory after a delay time period.

10. The method of claim 7,
wherein the first page fault information comprises a first number of page faults associated with the virtual machine at the first time instance and a second number of page faults associated with the virtual machine at the second time instance, and wherein the first page fault rate is determined from a ratio of a difference between the second number of page faults and the first number of page faults to a difference between the second time instance and the first time instance.

11. The method of claim 7, further comprising:
allocating the second amount such that a difference between the second amount and the first amount is a function of a difference between the first page fault rate and the threshold rate.

12. The method of claim 7, further comprising:
determining the threshold rate based on a number of guest physical processors associated with the virtual machine.

13. A non-transitory computer-readable medium having computer-readable instructions stored thereon, the instructions when executed by a processor, cause the processor to:
allocate a first amount of a host physical memory to a guest physical memory of a virtual machine;
receive first page fault information associated with the virtual machine at a first time instance and a second time instance;
determine, based on the first page fault information received at the first time instance and the second time instance, a first page fault rate;
determine that the first page fault rate is greater than a threshold rate; and
allocate a second amount, greater than the first amount, of the host physical memory to the guest physical memory.

14. The non-transitory computer-readable medium of claim 13, wherein the processor further comprises instructions to:
receive second page fault information subsequent to receiving the first page fault information;
determine, based on the second page fault information, a second page fault rate;
determine that the second page fault rate is less than the threshold rate; and
allocate a third amount, less than the second amount, of the host physical memory to the guest physical memory.

15. The non-transitory computer-readable medium of claim 14, wherein the processor further comprises instructions to:
receive third page fault information subsequent to receiving the second page fault information;
determine, based on the third page fault information, a third page fault rate;
determine that the third page fault rate is less than the threshold rate;
determine that the third page fault information is received greater than a delay time period after the receipt of the second page fault information; and
allocate a fourth amount, less than the third amount, of the host physical memory to the guest physical memory.

16. The non-transitory computer-readable medium of claim 13, wherein the first page fault information includes a first number of page faults associated with the virtual machine at the first time instance, and a second number of page faults associated with the virtual machine at the second time instance, wherein the first page fault rate is equal to a ratio of a difference between the second number of page faults and the first number of page faults to a difference between the second time instance and the first time instance.

17. The non-transitory computer-readable medium of claim 13, wherein a difference between the second amount and the first amount is a function of a difference between the first page fault rate and the threshold rate.

18. The non-transitory computer-readable medium of claim 13, wherein the threshold rate is based on a number of guest physical processors associated with the virtual machine.

19. The apparatus of claim 2, wherein the processor further includes programmed instructions to allocate the third amount of the host physical memory after a delay time period.

20. The non-transitory computer-readable medium of claim 14, wherein the processor further comprises instructions to allocate the third amount of the host physical memory after a delay time period.
